(19) United States
(12) Patent Application Publication
(10) Pub. No.: US 2025/0349146 A1
(43) Pub. Date: Nov. 13, 2025

(54) METHOD AND DEVICE FOR DETECTING CHILD

(71) Applicants: Hyundai Motor Company, Seoul (KR); Kia Corporation, Seoul (KR)

(72) Inventors: Sunwoo Lee, Hwaseong-Si (KR); Jaeseon Kim, Hwaseong-Si (KR)

(21) Appl. No.: 18/953,597

(22) Filed: Nov. 20, 2024

(30) Foreign Application Priority Data
May 10, 2024 (KR) 10-2024-0061714

(51) Int. Cl. G06V 40/10; G06T 7/50; G06T 7/70; G06V 10/26; G06V 20/58

(52) U.S. Cl. CPC G06V 40/10; G06T 7/50; G06T 7/70; G06V 10/26; G06V 20/58; G06T 2207/30196; G06T 2207/30244; G06T 2207/30252

(57) ABSTRACT

A method and a device may allow for detecting a child and controlling a mobile system (e.g., a vehicle and/or robot) that drives in a space where people may be. The method may include acquiring an image from a camera of the mobile system; extracting a first foot pixel coordinate corresponding to a foot of a person and a head pixel coordinate corresponding to a head of the person from the acquired image by using semantic segmentation; generating a bird's-eye view image from the acquired image; acquiring a second foot pixel coordinate, corresponding to the first foot pixel coordinate, in the bird's-eye view image; estimating a distance between the mobile system and the detected person based on the first foot pixel coordinate; and estimating a height of the detected person based on the distance and the head pixel coordinate.

### CROSS-REFERENCE TO RELATED APPLICATION

This application claims priority to and the benefit of Korean Patent Application No. 10-2024-0061714 filed in the Korean Intellectual Property Office on May 10, 2024, the entire contents of which are incorporated herein by reference.

### TECHNICAL FIELD

The disclosure relates to a method and a device for detecting a child.

### BACKGROUND

Mobile systems (e.g., vehicles, robots) may be designed in consideration of interaction with people, safety, user friendliness, etc., in order to drive in spaces where people exist. For example, because mobile systems, such as self-driving robots including delivery robots and/or cleaning robots, self-driving vehicles, warehouse robots, and/or self-driving pallets, drive in spaces where people live/work/exist, preventing collisions with people is important.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for controlling a vehicle (e.g., based on detecting a child and/or a height of a detected person). A method of controlling operation of a vehicle may comprise acquiring an image from a camera of the vehicle; extracting, based on semantic segmentation of the image: a first foot pixel coordinate corresponding to a foot of a person detected in the acquired image; and a head pixel coordinate corresponding to a head of the person; generating, based on transforming a coordinate system of the acquired image to a transformed coordinate system, a transformed view image; determining, based on the transformed view image, a second foot pixel coordinate, in the transformed view coordinate system, corresponding to the first foot pixel coordinate; estimating, based on the first foot pixel coordinate, a distance between the vehicle and the detected person; estimating, based on the distance and the head pixel coordinate, a height of the detected person; and controlling, based on the estimated height, an operation of the vehicle.

A device of a vehicle may comprise one or more processors configured to executes program codes loaded on one or more memory devices. The program codes, when executed by the one or more processors, may configure the device to: acquire an image from a camera of the vehicle, extract, based on semantic segmentation of the image: a first foot pixel coordinate corresponding to a foot of a person detected in the image; and a head pixel coordinate corresponding to a head of the person; generate, based on transforming a coordinate system of the acquired image to a transformed view coordinate system, a transformed view image; determine, based on the transformed view image, a second foot pixel coordinate, in the transformed view coordinate system, corresponding to the first foot pixel coordinate; estimate, based on the first foot pixel coordinate, a distance between the vehicle and the detected person; estimate, based on the distance and the head pixel coordinate, a height of the detected person; and control, based on the estimated height, an operation of the vehicle.

These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating a device for detecting a child according to an example.

FIG. 2 is a flowchart illustrating a method of detecting a child according to an example.

FIG. 3 shows an implementation example of a device and a method for detecting a child according to an example.

FIG. 4 shows an implementation example of a device and a method for detecting a child according to an example.

FIGS. 5 and 6 illustrate an implementation example of a device and a method for detecting a child according to an example.

FIG. 7 shows an implementation example of a device and a method for detecting a child according to an example.

FIG. 8 shows an implementation example of a device and a method for detecting a child according to an example.

FIG. 9 shows an implementation example of a device and a method for detecting a child according to an example.

FIG. 10 is a diagram illustrating a computing device according to an example.

### DETAILED DESCRIPTION

With reference to the attached drawings, examples of the disclosure will be described in detail below so that ordinary skilled in the art may easily implement the disclosure. However, the disclosure may be implemented in many different forms and is not limited to the examples described herein. In order to clearly explain the disclosure in the drawings, parts irrelevant to the description are omitted, and like reference numerals designate like elements throughout the specification. Unless otherwise defined, the terms used herein, including technical or scientific terms, may have meanings generally understood by those skilled in the art to which the present disclosure belongs.

Throughout the specification and the claims, unless explicitly described to the contrary, the word “comprise”, and variations such as “comprises” or “comprising”, may be understood to imply the inclusion of stated elements but not the exclusion of any other elements. The terms including ordinal numbers, such as first, second, etc. may be used to describe various elements, but the elements are not limited by the terms. The terms are used only for the purpose of distinguishing one element from another element. A singular expression used herein may include the meaning of the plural unless otherwise stated in the context, which also applies to the singular expression described in the claims.

The terms such as “component”, “portion”, “group”, “module”, “unit” and “means” in the specification may mean a unit/entity that processes/executes at least one function or operation described in the specification, which may be implemented as hardware or software or a combination of hardware and software. In addition, at least some components or functions of a device and a method for detecting a child according to the examples described below may be implemented as a program or software, and the program or software may be stored in a computer-readable medium. In particular, such terms generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

The expression “based on” as used herein is intended to describe one or more factors that influence an act or operation of determining or deciding described in a phrase or sentence including that expression, and this expression does not exclude any additional factors that influence the act or operation of determining or deciding.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Considering differences in behavior patterns between adults and children, it may be useful to separately detect/distinguish between adults and children separately in preventing/avoiding collisions, and control a vehicle/mobile system to avoid and/or keep safe the adult/children differently based on the detecting/distinguishing. For example, the vehicle/mobile system may be controlled to slow more when moving around/to avoid a child, avoid a child at a greater distance, stop and/or wait longer for a child to pass/move, stop further from a pedestrian area (e.g., cross-walk) with a child detected nearby (e.g., within a threshold distance), etc., relative to an adult. On the other hand, for the control and/or remote control of mobile systems, it may be beneficial to generate a bird's-eye view image so that a situation of the surrounding 360 degree may be checked at once. By distinguishing adults and children from each other in the bird's-eye view image, a collision avoidance policy or other operation for control of autonomous driving may be subdivided with respect to detected people being adults or children.

An operation control for autonomous driving of the mobile system/vehicle may include various driving control of the mobile system/vehicle by the device disclosed herein (e.g. a vehicle control device). For example, the various driving controls may comprise acceleration, deceleration, steering control, gear shifting control, braking system control, traction control, stability control, cruise control, lane keeping assist control, collision avoidance system control, emergency brake assistance control, traffic sign recognition control, adaptive headlight control, etc. Different controls/control settings may be applied depending on whether a detected person is an adult or a child.

A bird's-eye view may be a view taken above a certain distance from a ground and/or an object and may capture an area larger than a threshold (e.g., a threshold area configured in memory of the aerial vehicle). A bird's-eye view image may indicate (and/or may be associated with) a perspective angle from the aerial vehicle (e.g., row, yaw, pitch information of the aerial vehicle and/or one or more cameras of the aerial vehicle). For example, a bird's-eye view image may be generated by transforming a first coordinate system of a camera field of view, to a transformed coordinate system, e.g., of a bird's-eye view image. A bird's-eye view image may indicate (and/or may be associated with) time information and/or other indicators of a frame of the bird's-eye view image. A bird's-eye view image may indicate (and/or may be associated with) one or more landmark images included in the bird's-eye view image.

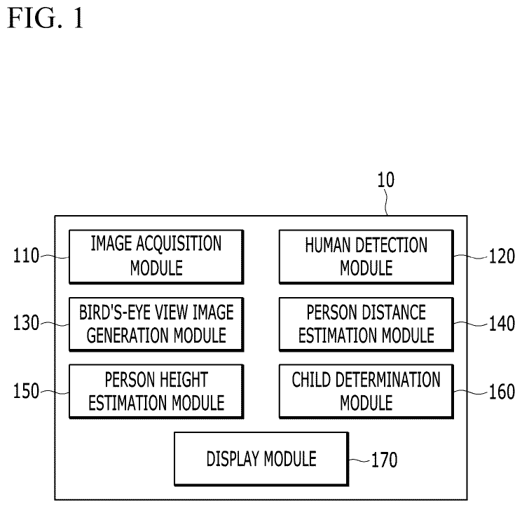

FIG. 1 is a block diagram illustrating a device for detecting a child according to an example.

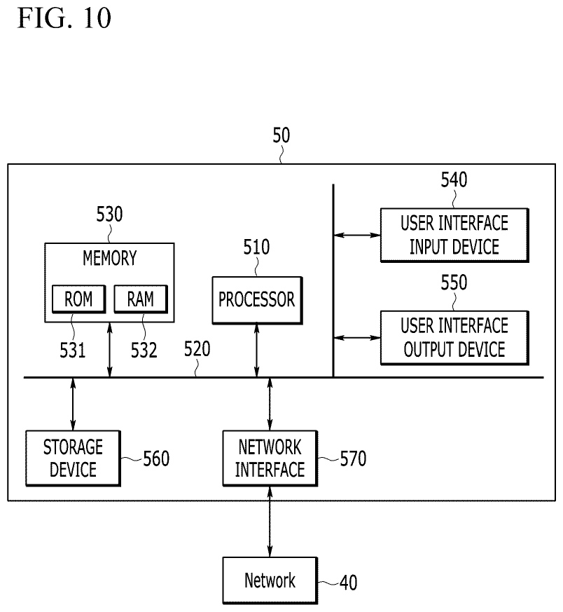

Referring to FIG. 1, a device 10 for detecting the child according to an example may execute, via one or more processors, one or more instructions (e.g., program codes) loaded/stored on one or more memory devices. For example, the device 10 for detecting the child may be implemented as a computing device 50 as described below with reference to FIG. 10. In this case, the one or more processors may correspond to a processor 510 of the computing device 50, and the one or more memory devices may correspond to a memory 520 of the computing device 50. The one or more instructions (e.g., program codes) may be executed by the one or more processors to perform a function of detecting the child. The one or more processors may be part of/in a mobile system (e.g., vehicle) configured to drive in a space where a person may exist.

The device 10 for detecting the child according to an example may include an image acquisition module 110, a human detection module 120, a bird's-eye view image generation module 130, a person distance estimation module 140, a person height estimation module 150, a child determination module 160, and a display module 170.

The image acquisition module 110 may acquire an image from a camera provided in a mobile system that implements mobility. Here, the mobile system may be a system that drives in a space where a person may live/work/exist. For example, the mobile system may be a self-driving robot such as a delivery robot or a cleaning robot, a self-driving vehicle, a warehouse robot, and/or a self-driving pallet. The scope of the mobile system herein is not limited to those examples listed.

In examples, the mobile system may include a plurality of monocular cameras. One or more of (e.g., each of) the monocular cameras may acquire/generate/obtain (e.g., via photography) an image by using a single optical lens system. Monocular cameras have the advantage of being uncomplicated, low-cost, and lightweight (e.g., as opposed to a stereo camera), and conveniently used in a variety of environments. In some examples, the mobile system may include a plurality of monocular cameras (e.g., two, three, four monocular cameras, etc.). Images acquired (e.g., photographed) via the one or more monocular cameras may be used to generate a bird's-eye view image of an area around the mobile system (e.g., of areas captured in a field of view of the one or more cameras).

Each camera of the one or more monocular cameras may have a corresponding FoV. A FoV may refer to the observable area that a camera (or other visual sensor) may capture at any given moment. It may be typically measured as an angle, representing the extent of the scene that may be seen horizontally, vertically, or diagonally. In the context of cameras and sensors, a wider FoV may allow more of the surroundings to be captured in a single image or scan, which may be useful to applications (e.g., photography, video recording, virtual reality, and/or autonomous navigation, etc.). A FoV for a given camera may be affected by a plurality of factors such as the lens design, sensor size, and/or the distance between the observer or device and the objects being observed. Different cameras of the plurality of cameras (in a case that the one or more monocular cameras comprise a plurality of cameras) may have different (e.g., distinct and/or partially overlapping) fields of view (FoV). Images (e.g., still images and/or video images) acquired by the plurality of monocular cameras may be combined (e.g., stitched together) to form a single image having a combined FoV including the FoVs of each camera combined. The image the image acquisition module 110 as discussed herein may be an image acquired by a single camera of the one or more cameras, or a combined image formed from corresponding images acquired by a plurality of the monocular cameras (e.g., in a case that the one or more monocular cameras are a plurality of monocular cameras).

The person detection module 120 may detect a person in one or more of the images acquired via the image acquisition module 110. In some examples, the person detection module 120 may comprise/execute an object-recognition and/or classification algorithm. In some examples, the person detection module 120 may a machine learning model, such as a convolutional neural network (CNN), a region-based CNN (R-CNN), transfer learning trained model, etc., to detect the person in the image.

The person detection module 120 may detect, in each of (e.g., at least one of) the one or more image of the images acquired via the image acquisition module 110 and having a person recognized therein, a pixel corresponding to a foot of a person by using semantic segmentation and extract a first foot pixel coordinate p_{foot} with respect to the corresponding pixel. The first foot pixel coordinate p_{foot} may include an x-coordinate x_{foot} indicating a position in an x-axis of the image and a y-coordinate y_{foot} indicating a position in a y-axis of the image, as follows.

$${p}_{foot} = ( {x}_{foot} , {y}_{foot} )$$

The person detection module 120 may detect, in each of (e.g., at least one of) the one or more image and for which a pixel corresponding to the foot of the person was extracted, a pixel corresponding to the persons' head by using semantic segmentation and extract a head pixel coordinate p_{head} with respect to the corresponding pixel. The head pixel coordinate p_{head} may include an x-coordinate x_{head} and a y-coordinate y_{head}, as follows.

$${p}_{head} = ( {x}_{head} , {y}_{head} )$$

Semantic segmentation allows for classifying to which category each pixel in an image belongs. A label may be assigned, via semantic segmentation, to each pixel constituting the image. Accordingly, various objects in the image (and/or the constitutive pixels) may be accurately classified. The person detection module 20 may identify, at the pixel level through semantic segmentation, shapes and/or boundaries corresponding to/indicating a person, a foot of the person, and/or a head of the person in the image. For example, in a process of extracting features from an image by using a deep learning model such as CNN, various information may be extracted from low-level features such as edges, colors, and/or textures of the image to high-level features such as shapes of objects and relationships between objects. Based on the extracted features, a neural network may classify each pixel of the image into one of a plurality of predefined categories to generate segmentation map. The segmentation map (e.g., in which a color code is designated according to one or more categories) may be output.

In some examples, the first foot pixel coordinate p_{foot} may be set/selected as a coordinate of a specific pixel in a segmentation map region representing the foot of the person. For example, the segmentation map region representing the foot of the person may be set/selected as a first temporary region. The first temporary region may be a region corresponding to the foot of the person detected in the image acquired via the image acquisition module 110. A coordinate of the lowermost pixel, among one or more pixels, included in the first temporary region may be extracted as the first foot pixel coordinate p_{foot}. Also, or alternatively, another pixel, such as a center (e.g., center of mass) pixel may be selected as the first foot pixel coordinate p_{foot}.

In some examples, the head pixel coordinate p_{head} may be set as a coordinate of a specific pixel in a segmentation map region representing the head of the person. For example, the segmentation map region representing the head of the person may be set as a second temporary region. The second temporary region may be a region corresponding to the head of the person detected in the image acquired via the image acquisition module 110. A coordinate of the uppermost pixel, among one or more pixels included in the second temporary region, may be extracted as the head pixel coordinate p_{head}. Also, or alternatively, another pixel, such as a center (e.g., center of mass) pixel may be selected as the first head pixel coordinate p_{head}.

The bird's-eye view image generation module 130 may generate a bird's-eye view image from/based on the image acquired via the image acquisition module 110. The bird's-eye view image may express an object or an environment around the mobile system at an angle looking down (e.g., from the sky, from a ceiling, etc.) so that the overall structure and/or arrangement of objects over a ground area may be identified at a glance.

In some examples, the bird's-eye view image generation module 130 may acquire intrinsic parameters and/or extrinsic parameters of the camera to generate the bird's-eye view image. The intrinsic parameters may be information unique to the camera and may represent characteristics of a lens and/or an image sensor of the camera. For example, the intrinsic parameters may include a focal length corresponding to a distance from the center of the lens to the image sensor, a principal point at which an optical axis meets an image plane on the image sensor, a distortion coefficient to calibrate geometric distortion and optical distortion of the lens, a scale factor representing the effect of a pixel size of the image sensor on an actual distance unit, etc. The extrinsic parameters may represent a position and/or a direction of the camera, and/or may include, for example, a rotation matrix representing the direction of the camera in a three-dimensional (3D) space, a vector representing the position of the camera, etc.

The bird's-eye view image generation module 130 may convert each point on the image acquired via the image acquisition module 110 into a point on the bird's-eye view image by using/based on a homography matrix. The homography matrix is a transformation matrix that can be used to convert (and/or project) an image in one (a first) plane to another (a second) plane. The homography matrix and be, for example, a 3×3 transformation matrix. If distortion occurs in a process of converting each point of the image acquired via the image acquisition module 110 into a transformed point of the bird's-eye view image by using the homography matrix, calibration may be performed based on (e.g., by using) the intrinsic parameters of the camera.

The bird's-eye view image generation module 130 may generate a look-up table based on a result of the conversion. The bird's-eye view image generation module 130 may generate the bird's-eye view image (e.g., in real time) based on the image acquired via the image acquisition module 110 based on (e.g., by using) the look-up table. The look-up table may store previously calculated mapping from a position of each pixel of an original image (e.g., the image acquired via the image acquisition module 110) to a corresponding position on the bird's-eye view image. For example, the previous image acquired via the image acquisition module 110 may be stored, and the lookup table may contain the prepared mappings in advance to accelerate the generation of the bird's-eye view. Accordingly, it is possible to quickly generate a bird's-eye view in a real-time image processing process.

The person distance estimation module 140 may estimate, based on the first foot pixel coordinate p_{foot}, a distance dₚₑᵣₛₒₙ between the mobile system and the person detected in the image acquired via the image acquisition module 110. Specifically, the person distance estimation module 140 may set the first foot pixel coordinate p_{foot} and the coordinate of the camera in a normalized coordinate system, set coordinates corresponding to the coordinates set on the normalized coordinate system on a world coordinate system (alternately a bird's-eye view coordinate system, herein), and then, estimate, based on the coordinates set on the world coordinate system in response to the first foot pixel coordinate p_{foot} and the coordinate of the camera, the distance dₚₑᵣₛₒₙ between the mobile system and the person detected in the image acquired via the image acquisition module 110.

The person height estimation module 150 may estimate, based on the distance dₚₑᵣₛₒₙ estimated by the person distance estimation module 140 and the head pixel coordinate p_{head} extracted by the person detection module 120, a height hₚₑᵣₛₒₙ of the person detected in the image acquired via the image acquisition module 110.

If a value of the height hₚₑᵣₛₒₙ estimated by the person height estimation module 150 is within a predetermined range (e.g., satisfies a child height criteria, is equal to or below a threshold, below a threshold), the child determination module 160 may determine that the person detected in the image acquired via the image acquisition module 110 is the child. Alternatively, if the value of the height hₚₑᵣₛₒₙ estimated by the person height estimation module 150 is not within the range (e.g., does not satisfy the child height criteria, is greater than the threshold, is greater than or equal to the threshold), the child determination module 160 may determine that the person detected in the image acquired through the image acquisition module 110 is not the child.

The bird's-eye view image generation module 130 may acquire/generate a second foot pixel coordinate p′_{foot}, from the bird's-eye view image (e.g., in the bird's-eye view and/or world coordinate system), corresponding to the first foot pixel coordinate p_{foot}. In some examples, the bird's-eye view image generation module 130 may acquire/generate, via the homography matrix, the second foot pixel coordinate p′_{foot} corresponding to the first foot pixel coordinate p_{foot}.

The display module 170 may display, on the bird's-eye view image, the second foot pixel coordinate p′_{foot} acquired by the bird's-eye view image generation module 130 and a result of determining whether the person detected in the image acquired through the image acquisition module 110 is the child by the child determination module 160.

According to the present example, it is possible to accurately measure the distance to a person by using only a monocular camera, and without using expensive equipment such as a LiDAR or a Red Green Blue-Depth (RGB-D) camera. The distance to the person may be used to estimate a height of the person, which may be used to identify whether the person is an adult or a child. The classification as an adult or child may be used to differently control the mobile system to prevent collisions with the person (e.g., when the mobile system drives autonomously and/or via traffic control). In particular, by detecting the person in the bird's-eye view image, and distinguishing between an adult and a child, it is possible to subdivide/select the collision avoidance policy of the mobile system accordingly and provide customized services and contents related to mobility.

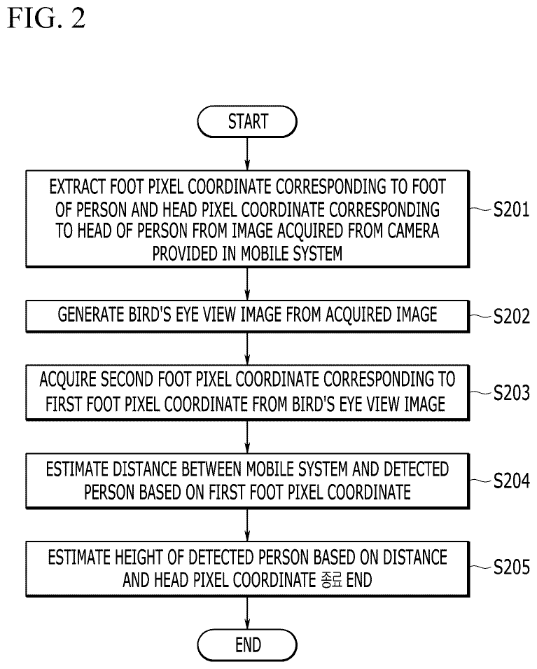

For convenience, FIGS. 2-5 and 7-10 are described by way of examples in which the steps are performed by a processor circuit. One, some, or all steps of the example methods of FIGS. 2-5 and 7-10, or portions thereof, may be performed by one or more other circuits. One or some, steps of the example methods of FIGS. 2-5 and 7-10 may be omitted, performed in other orders, and/or otherwise modified, and/or one or more additional steps may be added.

FIG. 2 is a flowchart illustrating a method of detecting a child according to an example.

Referring to FIG. 2, the method of detecting the child according to an example may include extracting a foot pixel coordinate corresponding to a foot of a person and a head pixel coordinate corresponding to a head of the person from an image acquired from one or more cameras (e.g., one or more monocular cameras) provided in a mobile system S201, generating a bird's-eye view image from the acquired image S202, acquiring a second foot pixel coordinate, corresponding to a first foot pixel coordinate, from the bird's-eye view image S203, estimating a distance between the mobile system and a detected person based on the first foot pixel coordinate S204, and estimating a height of the detected person based on the distance and the head pixel coordinate S205.

For more detailed information about the method of detecting the child, the description of examples described in the specification may be referred to, and thus, redundant descriptions are omitted here (see, e.g., the description of the steps described herein.

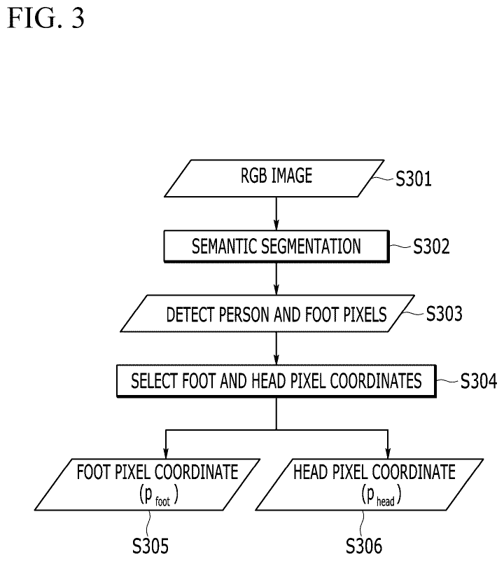

FIG. 3 shows an implementation example of a device and a method for detecting a child.

Referring to FIG. 3, the implementation example of the device and the method for detecting the child may include receiving an RGB image from one or more camera including a mobile system in step S301, performing semantic segmentation in step S302, and detecting person and/or foot pixels in step S303. The implementation example may include, in step S304, selecting pixel coordinates of a foot and a head based on a segmentation map obtained via semantic segmentation (of step S302 and/or S303), extracting the first foot pixel coordinate p_{foot} in step S305, and extracting the head pixel coordinate p_{head} in step S306.

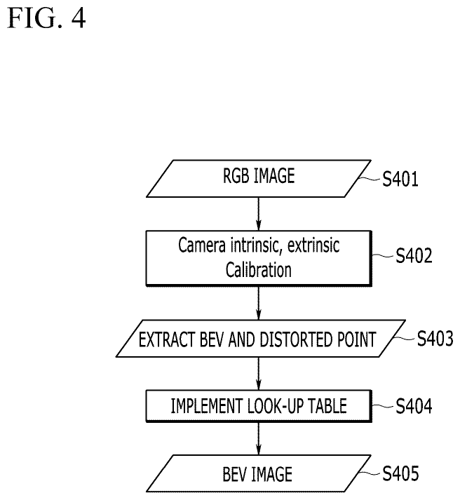

FIG. 4 shows an implementation example of a device and a method for detecting a child.

Referring to FIG. 4, the implementation example of the device and the method for detecting the child may include receiving an image (e.g., an RGB image) from one or more cameras (e.g., one or more monocular cameras) of (e.g., associated with, on, etc.) a mobile system in step S401, and calibrating intrinsic parameters and/or extrinsic parameters of the camera in step S402. The implementation example may include converting each point of an acquired image (from the one or more cameras, where the image may be from a single camera or combined from a plurality of cameras) into a point on a bird's-eye view image, extracting a distorted point, and performing calibration in step S403, implementing, in step S404, a look-up table that stores previously calculated mapping from a position of each pixel of an original image to a corresponding position on the bird's-eye view image, and generating (e.g., quickly/in real or near real-time) a bird's-eye view image in step S405.

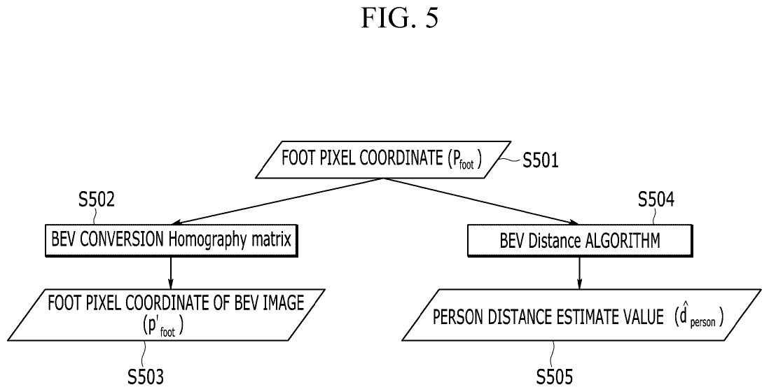

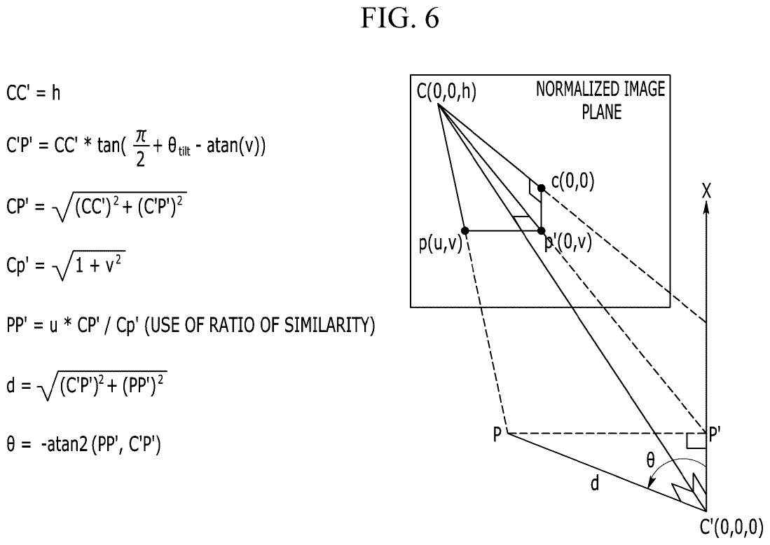

FIGS. 5 and 6 illustrate an implementation example of a device and a method for detecting a child.

Referring to FIG. 5, the implementation example of the device and the method for detecting the child may include providing the first foot pixel coordinate p_{foot} in step S501, receiving a homography matrix for conversion of a bird's-eye view image in step S502, and obtaining the second foot pixel coordinate p′_{foot}, corresponding to the first foot pixel coordinate p_{foot}, in the bird's-eye view image in step S503. The implementation example may include receiving an algorithm for estimating a distance based on the bird's-eye view image in step S504 (e.g., following step S501) and estimating the distance dₚₑᵣₛₒₙ between the mobile system and a person detected in the image in step S505.

Referring to FIG. 6, step S505 may include estimating the distance dₚₑᵣₛₒₙ by using Equation 1 below.

$$d = \sqrt{{( {C}^{′} {P}^{′} )}^{2} + {( {PP}^{′} )}^{2}} \qquad ( Equation 1 )$$

Here, d may denote the distance dₚₑᵣₛₒₙ, and C′P′ may be calculated by using Equation 2 below.

$${C}^{′} {P}^{′} = {CC}^{′} * tan ( \frac{π}{2} + {θ}_{tilt} - {tan}^{- 1} v ) \qquad ( Equation 2 )$$

Here, CC′ may denote a height of a camera, θₜᵢₗₜ may denote a tilt angle of the camera, v may denote a y coordinate of the first foot pixel coordinate p_{foot}, and PP′ may be calculated by using Equation 3 below.

$${PP}^{′} = u * \frac{{CP}^{′}}{{Cp}^{′}} \qquad ( Equation 3 )$$

Here, u may denote an x coordinate of the first foot pixel coordinate p_{foot}, CP′ may be calculated by using Equation 4 below, and Cp′ may be calculated by using Equation 5 below.

$${CP}^{′} = \sqrt{{( {CC}^{′} )}^{2} + {( {C}^{′} {P}^{′} )}^{2}} \qquad ( Equation 4 )$$

$${Cp}^{′} = \sqrt{1 + {v}^{2}} \qquad ( Equation 5 )$$

Here, CC′ may denote the height of the camera, v may denote the y coordinate of the first foot pixel coordinate p_{foot}, and C′P′ may be calculated by using Equation 2 above.

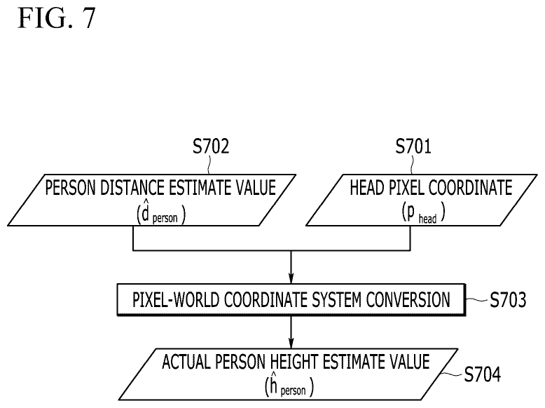

FIG. 7 shows an implementation example of a device and a method for detecting a child.

Referring to FIG. 7, the implementation example of the device and the method for detecting the child may include receiving the head pixel coordinate p_{head} in step S701, receiving the distance dₚₑᵣₛₒₙ between a mobile system and a person detected in an image in step S702, performing a pixel to world coordinate system conversion in step S703, and estimating, in step S704, the height hₚₑᵣₛₒₙ of the person detected in the image based on the distance dₚₑᵣₛₒₙ and the head pixel coordinate p_{head}.

Step S704 may include estimating Z of coordinates (X, Y, Z) obtained by converting the head pixel coordinate p_{head} (x, y) of the acquired image into a world coordinate system as the height hₚₑᵣₛₒₙ by using Equation 6 below.

$$[ \begin{matrix}X \\ Y \\ Z \\ 1\end{matrix} ] = {s [ R \vert t ]}^{- 1} {K}^{- 1} [ \begin{matrix}x \\ y \\ 1\end{matrix} ] \qquad ( Equation 6 )$$

Here, K may denote an intrinsic parameter matrix of a camera, [R|t] may denote an extrinsic parameter matrix of the camera, and s may denote the distance dₚₑᵣₛₒₙ.

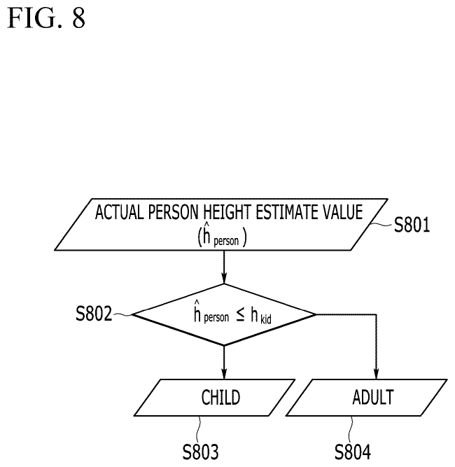

FIG. 8 shows an implementation example of a device and a method for detecting a child.

Referring to FIG. 8, the implementation example of the device and the method for detecting the child may include receiving the height hₚₑᵣₛₒₙ of a person detected in an image estimated based on the distance dₚₑᵣₛₒₙ and the head pixel coordinate p_{head} in step S801, and compare the height hₚₑᵣₛₒₙ with a predetermined reference height h_{kid} (e.g., 120 cm) in step S802. The implementation example may include, when the height hₚₑᵣₛₒₙ is less than or equal to the reference height h_{kid} in step S803, determining that the person detected in the image is the child, and when the height hₚₑᵣₛₒₙ exceeds the reference height h_{kid} in step S804, determining that the person detected in the image is an adult.

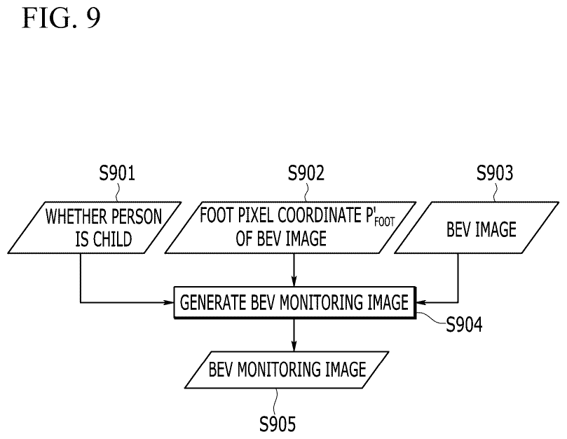

FIG. 9 shows an implementation example of a device and a method for detecting a child.

Referring to FIG. 9, the implementation example of the device and the method for detecting the child may include receiving a result of whether a person is the child in step S901, receiving the second foot pixel coordinate p′_{foot} of a bird's-eye view image in step S902, receiving the bird's-eye view image in step S903, generating a bird's-eye view monitoring image in step S904, and outputting the bird's-eye view monitoring image in step S905. The monitoring image may be an image obtained by aggregating the outputs of steps S901, S902, and S903. The outputting the bird's-eye view monitoring image may be based determining that the detected person is a child. Also, or alternatively, the method disclosed herein may comprise controlling operation of the mobile system (e.g., a speed, a movement, etc.) based on rules/safety policies associated with detection of a child as opposed to detection of an adult. For example, the rules/safety policies may comprise causing the mobile system to move slower, avoid the detected child at a greater distance, stopping for longer at a greater distance from pedestrian marked areas (e.g., sidewalks, crosswalks, bike lanes, etc.) based on the determining that the detected person is a child in S901. The rules/safety policies may be received (e.g., via a network, via user input) by the device 10 and configured to cause different operation of the mobile system depending on whether a detected person is determined to be an adult or a child.

FIG. 10 is a diagram illustrating a computing device according to an example.

Referring to FIG. 10, a method and a device for detecting a child according to examples may be implemented by using the computing device 50 (e.g., the device 10 may comprise the computing device 50, as described herein).

The computing device 50 may include at least one processor 510, a memory 530, a user interface input device 540, a user interface output device 550, and/or a storage device 560. The components of computing device 50 may be configured to communicate with each other over a bus 520. The computing device 50 may also, or alternatively, include a network interface 570 that is communicatively connected to a network 40 (e.g., an external network, such as the internet, a vehicle-to-vehicle network, vehicle-to-infrastructure network, vehicle-to-everything network). The network interface 570 may transmit or receive signals to and from other entities through the network 40.

The at least one processor 510 may be implemented as one or more of a variety of types, such as a Micro Controller Unit (MCU), Application Processor (AP), Central Processing Unit (CPU), Graphic Processing Unit (GPU), Neural Processing Unit (NPU), and/or Quantum Processing Unit (QPU). The at least one processor 510 and may be any (e.g., semiconductor) device configured to execute instructions/commands stored in the memory 530 or the storage device 560. The at least one processor 510 may be configured to implement the functions and/or methods described above with respect to FIGS. 1 to 9.

The memory 530 and the storage device 560 may include various types of volatile or non-volatile storage media. For example, the memory 530 may include read-only memory (ROM) 531 and random access memory (RAM) 532. In some examples, the memory 530 may be located inside or outside the processor 510, and the memory 530 may be communicatively connected to the at least one processor 510.

In some examples, at least some components or functions of the method and the device for detecting the child according to the examples may be implemented by instructions (e.g. a program and/or software) executed by the computing device 50, and the instructions (e.g., program and/or software) may be stored in a computer-readable medium. The non-transitory computer-readable medium according to an example may record the instructions (e.g., the program and/or software) for executing steps included in implementation of the method and the device for detecting the child according to the examples, on a computer including the processor 510 configured to execute the instructions (e.g., the program and/or command) stored in the memory 530 and/or the storage device 560.

In some examples, at least some components or functions of the method and the device for detecting the child according to the examples may be implemented by using hardware or circuit of the computing device 50, or may be implemented as separate hardware or circuit that may be electrically connected to the computing device 50. For example, the device 10 may comprise computing device 50, which may comprise one or more processors and a memory storing instructions (e.g., programs and/or commands) that, when executed by the one or more processors, cause the computing device 50 to perform the methods disclosed herein.

The present disclosure attempts to provide a method and a device for detecting a child capable of separately detecting an adult and a child and avoid collisions in a mobile system that implements mobility.

According to an example, a method of detecting a child in a mobile system that drives in a space where a person exists includes acquiring an image from a camera provided in the mobile system; extracting a first foot pixel coordinate corresponding to a foot of a person and a head pixel coordinate corresponding to a head of the person from the acquired image by using semantic segmentation; generating a bird's-eye view image from the acquired image; acquiring a second foot pixel coordinate corresponding to the first foot pixel coordinate from the bird's-eye view image; estimating a distance between the mobile system and the detected person based on the first foot pixel coordinate; and estimating a height of the detected person based on the distance and the head pixel coordinate.

In some examples, the method may further include, when a value of the height is within a predetermined range, determining that the detected person is the child, and when the value of the height is not within the range, determining that the detected person is not the child.

In some examples, the method may further include displaying, on the bird's-eye view image, the second foot pixel coordinate and a result of determining whether the detected person is the child.

In some examples, the extracting of the first foot pixel coordinate and the head pixel coordinate may include setting a region corresponding to the foot of the person detected from the acquired image as a first temporary region; and extracting a coordinate of a lowermost pixel among one or more pixels included in the first temporary region as the first foot pixel coordinate.

In some examples, the extracting of the first foot pixel coordinate and the head pixel coordinate may include setting a region corresponding to the head of the person detected from the acquired image as a second temporary region; and extracting a coordinate of an uppermost pixel among one or more pixels included in the second temporary region as the head pixel coordinate.

In some examples, the generating of the bird's-eye view image may include obtaining intrinsic parameters and extrinsic parameters of the camera; converting each point on the acquired image into a point on the bird's-eye view image through a homography matrix; generating a look-up table based on a result of the converting; and generating the bird's-eye view image in real time from the acquired image by using the look-up table.

In some examples, the acquiring of the second foot pixel coordinate may include acquiring the second foot pixel coordinate corresponding to the first foot pixel coordinate through the homography matrix.

In some examples, the estimating of the distance may include setting the first foot pixel coordinate and a coordinate of the camera in a normalized coordinate system; setting coordinates corresponding to coordinates set on the normalized coordinate system on a world coordinate system; and estimating a distance between the mobile system and the detected person based on the coordinates set on the world coordinate system in correspondence to the first foot pixel coordinate and the coordinate of the camera.

In some examples, the estimating of the distance may include estimating the distance by using Equation 1 below:

$$d = \sqrt{{( {C}^{′} {P}^{′} )}^{2} + {( {PP}^{′} )}^{2}} \qquad ( Equation 1 )$$

Here, d denotes the distance, and C′P′ is calculated by using Equation 2 below:

$${C}^{′} {P}^{′} = {CC}^{′} * tan ( \frac{π}{2} + {θ}_{tilt} - {tan}^{- 1} v ) \qquad ( Equation 2 )$$

Here, CC′ denotes a height of the camera, θₜᵢₗₜ denotes a tilt angle of the camera, v denotes a y coordinate of the first foot pixel coordinate, and PP′ is calculated by using Equation 3 below:

$${PP}^{′} = u * \frac{{CP}^{′}}{{Cp}^{′}} \qquad ( Equation 3 )$$

Here, u denotes an x coordinate of the first foot pixel coordinate, CP′ is calculated by using Equation 4 below, and Cp′ is calculated by using Equation 5 below:

$${CP}^{′} = \sqrt{{( {CC}^{′} )}^{2} + {( {C}^{′} {P}^{′} )}^{2}} \qquad ( Equation 4 )$$

$${Cp}^{′} = \sqrt{1 + {v}^{2}} \qquad ( Equation 5 )$$

Here, CC′ denotes the height of the camera, v denotes the y coordinate of the first foot pixel coordinate, and C′P′ is calculated by using Equation 2 above.

In some examples, the estimating of the height may include estimating Z of coordinates (X, Y, Z) obtained by converting the head pixel coordinate (x, y) into a world coordinate system as the height by using Equation 6 below:

$$[ \begin{matrix}X \\ Y \\ Z \\ 1\end{matrix} ] = {s [ R \vert t ]}^{- 1} {K}^{- 1} [ \begin{matrix}x \\ y \\ 1\end{matrix} ] \qquad ( Equation 6 )$$

Here, K denotes an intrinsic parameter matrix of the camera, [R|t] denotes an extrinsic parameter matrix of the camera, and s denotes the distance.

According to an example, a device for detecting a child in a mobile system that executes program codes loaded on one or more memory devices through one or more processors and driving in a space where a person exists, wherein the program codes may be executed to acquire an image from a camera provided in the mobile system, extract a first foot pixel coordinate corresponding to a foot of a person and a head pixel coordinate corresponding to a head of the person from the acquired image by using semantic segmentation, generate a bird's-eye view image from the acquired image, acquire a second foot pixel coordinate corresponding to the first foot pixel coordinate from the bird's-eye view image, estimate a distance between the mobile system and the detected person based on the first foot pixel coordinate, and estimate a height of the detected person based on the distance and the head pixel coordinate.

In some examples, the program codes may be executed to, when a value of the height is within a predetermined range, determine that the detected person is the child, and when the value of the height is not within the range, determine that the detected person is not the child.

In some examples, the program codes may be executed to display, on the bird's-eye view image, the second foot pixel coordinate and a result of determining whether the detected person is the child.

In some examples, the extracting of the first foot pixel coordinate and the head pixel coordinate may include setting a region corresponding to the foot of the person detected from the acquired image as a first temporary region; and extracting a coordinate of a lowermost pixel among one or more pixels included in the first temporary region as the first foot pixel coordinate.

In some examples, the extracting of the first foot pixel coordinate and the head pixel coordinate may include setting a region corresponding to the head of the person detected from the acquired image as a second temporary region; and extracting a coordinate of an uppermost pixel among one or more pixels included in the second temporary region as the head pixel coordinate.

In some examples, the generating of the bird's-eye view image may include obtaining intrinsic parameters and extrinsic parameters of the camera, converting each point on the acquired image into a point on the bird's-eye view image through a homography matrix, generating a look-up table based on a result of the converting, and generating the bird's-eye view image in real time from the acquired image by using the look-up table.

In some examples, the acquiring of the second foot pixel coordinate may include acquiring the second foot pixel coordinate corresponding to the first foot pixel coordinate through the homography matrix.

In some examples, the estimating of the distance may include setting the first foot pixel coordinate and a coordinate of the camera in a normalized coordinate system, setting coordinates corresponding to coordinates set on the normalized coordinate system on a world coordinate system, and estimating a distance between the mobile system and the detected person based on the coordinates set on the world coordinate system in correspondence to the first foot pixel coordinate and the coordinate of the camera.

In some examples, the estimating of the distance may include estimating the distance by using Equation 1 below:

$$d = \sqrt{{( {C}^{′} {P}^{′} )}^{2} + {( {PP}^{′} )}^{2}} \qquad ( Equation 1 )$$

Here, d denotes the distance, and C′P′ is calculated by using Equation 2 below:

$${C}^{′} {P}^{′} = C {C}^{′} * tan ( \frac{π}{2} + {θ}_{tilt} - {tan}^{- 1} v ) \qquad ( Equation 2 )$$

Here, CC′ denotes a height of the camera, θₜᵢₗₜ denotes a tilt angle of the camera, v denotes a y coordinate of the first foot pixel coordinate, and PP′ is calculated by using Equation 3 below:

$$P {P}^{′} = u * \frac{{CP}^{′}}{{Cp}^{′}} \qquad ( Equation 3 )$$

Here, u denotes an x coordinate of the first foot pixel coordinate, CP′ is calculated by using Equation 4 below, and Cp′ is calculated by using Equation 5 below:

$$C {P}^{′} = \sqrt{{( {CC}^{′} )}^{2} + {( {C}^{′} {P}^{′} )}^{2}} \qquad ( Equation 4 )$$

$$C {p}^{′} = \sqrt{1 + {v}^{2}} \qquad ( Equation 5 )$$

Here, CC′ denotes the height of the camera, v denotes the y coordinate of the first foot pixel coordinate, and C′P′ is calculated by using Equation 2 above.

In some examples, the estimating of the height may include estimating Z of coordinates (X, Y, Z) obtained by converting the head pixel coordinate (x, y) into a world coordinate system as the height by using Equation 6 below:

$$[ \begin{matrix}X \\ Y \\ Z \\ 1\end{matrix} ] = {s [ R \vert t ]}^{- 1} {K}^{- 1} [ \begin{matrix}x \\ y \\ 1\end{matrix} ] \qquad ( Equation 6 )$$

Here, K denotes an intrinsic parameter matrix of the camera, [R|t] denotes an extrinsic parameter matrix of the camera, and s denotes the distance.

According to the disclosure herein, it is possible to accurately measure the distance to a person by using only a monocular camera without using expensive equipment such as a LiDAR or a RGB-D camera, and to prevent collisions with the person when the mobile system drives autonomously or through traffic control. In particular, by detecting the person in the bird's-eye view image but distinguishing between an adult and a child, it is possible to subdivide the collision avoidance policy of the mobile system accordingly and provide customized services and contents related to mobility.

Although the examples of the disclosure have been described in detail above, the scope of the disclosure is not limited thereto, and various modifications and improvements made by those of ordinary skill in the field to which the disclosure pertains also belong to the scope of the disclosure.

What is claimed is:

1. A method of controlling operation of a vehicle, the method comprising:
acquiring an image from a camera of the vehicle;
extracting, based on semantic segmentation of the image:
a first foot pixel coordinate corresponding to a foot of a person detected in the acquired image; and
a head pixel coordinate corresponding to a head of the person;
generating, based on transforming a coordinate system of the acquired image to a transformed coordinate system, a transformed view image;
determining, based on the transformed view image, a second foot pixel coordinate, in the transformed view coordinate system, corresponding to the first foot pixel coordinate;
estimating, based on the first foot pixel coordinate, a distance between the vehicle and the detected person;
estimating, based on the distance and the head pixel coordinate, a height of the detected person; and
controlling, based on the estimated height, an operation of the vehicle.

2. The method of claim 1, further comprising:
determining, based on a value of the height being within a predetermined range, that the detected person is a child, or
determining, based on the value being outside of the predetermined range, that the detected person is not a child.

3. The method of claim 2, further comprising:
displaying, on the transformed view image:
the second foot pixel coordinate; and
a result of determining whether the detected person is a child.

4. The method of claim 1, wherein:
the extracting the first foot pixel coordinate comprises:
setting a first temporary region to be a region corresponding to the foot of the person detected in the acquired image; and
extracting a coordinate of a lowermost pixel, of one or more pixels in the first temporary region, as the first foot pixel coordinate.

5. The method of claim 1, wherein:
the extracting the head pixel coordinate comprise:
setting a second temporary region to be a region corresponding to the head of the person detected in the acquired image; and
extracting a coordinate of an uppermost pixel, of one or more pixels in the second temporary region, as the head pixel coordinate.

6. The method of claim 1, wherein: the generating of the transformed view image comprises:
obtaining intrinsic and extrinsic parameters of the camera;
converting, via a homography matrix based on the intrinsic and extrinsic parameters, each point, of a plurality of points in the acquired image, into a point in the transformed view image;
generating, based on the converting, a look-up table; and
generating, based on the look-up table and the acquired image, the transformed view image.

7. The method of claim 6, further comprising:
acquiring, based on the homography matrix, the second foot pixel coordinate corresponding to the first foot pixel coordinate.

8. The method of claim 1, wherein the estimating the distance comprises:
setting the first foot pixel coordinate and a coordinate of the camera in a normalized coordinate system;
determining corresponding coordinates in a world coordinate system, wherein the corresponding coordinates correspond to the first foot pixel coordinate and the coordinate of the camera in the normalized coordinate system; and
estimating, based on the corresponding coordinates in the world coordinate, a distance between the vehicle and the detected person.

9. The method of claim 1, wherein:
the estimating of the distance comprises
estimating the distance by using Equation 1 below:
$$d = \sqrt{{( {C}^{′} {P}^{′} )}^{2} + {( {PP}^{′} )}^{2}} \qquad Equation 1$$
where d denotes the distance, and C′P′ is calculated by using Equation 2:
$${C}^{′} {P}^{′} = {CC}^{′} * tan ( \frac{π}{2} + {θ}_{tilt} - {tan}^{- 1} v ) \qquad Equation 2$$
where, CC′ denotes a height of the camera, θₜᵢₗₜ denotes a tilt angle of the camera, v denotes a y coordinate of the first foot pixel coordinate, and PP′ is calculated by using Equation 3:
$${PP}^{′} = u * \frac{{CP}^{′}}{{Cp}^{′}} \qquad Equation 3$$
where, u denotes an x coordinate of the first foot pixel coordinate, CP′ is calculated by using Equation 4, and Cp′ is calculated by using Equation 5:
$${CP}^{′} = \sqrt{{( {CC}^{′} )}^{2} + {( {C}^{′} {P}^{′} )}^{2}} \qquad Equation 4$$
$${Cp}^{′} = \sqrt{1 + {v}^{2}} \qquad Equation 5$$
where, CC′ denotes the height of the camera, v denotes the y coordinate of the first foot pixel coordinate, and C′P′ is calculated by using Equation 2.

10. The method of claim 1, wherein the estimating the height comprises:
estimating, as the height, a value of Z of coordinates (X, Y, Z) obtained by converting the head pixel coordinate (x, y) into a world coordinate system by using Equation 6:
$$[ \begin{matrix}X \\ Y \\ Z \\ 1\end{matrix} ] = {s [ R \vert t ]}^{- 1} {K}^{- 1} [ \begin{matrix}x \\ y \\ 1\end{matrix} ] \qquad Equation 6$$
where, K denotes an intrinsic parameter matrix of the camera, [R|t] denotes an extrinsic parameter matrix of the camera, and s denotes the distance.

11. A device of a vehicle, wherein the device comprises one or more processors configured to executes program codes loaded on one or more memory devices, wherein:
the program codes, when executed by the one or more processors, configure the device to:
acquire an image from a camera of the vehicle,
extract, based on semantic segmentation of the image:
a first foot pixel coordinate corresponding to a foot of a person detected in the image; and
a head pixel coordinate corresponding to a head of the person;
generate, based on transforming a coordinate system of the acquired image to a transformed view coordinate system, a transformed view image;
determine, based on the transformed view image, a second foot pixel coordinate, in the transformed view coordinate system, corresponding to the first foot pixel coordinate;
estimate, based on the first foot pixel coordinate, a distance between the vehicle and the detected person;
estimate, based on the distance and the head pixel coordinate, a height of the detected person; and
control, based on the estimated height, an operation of the vehicle.

12. The device of claim 11, wherein the program codes, when executed by the one or more processors, configure the device to:
determine, based on a value of the height being within a predetermined range, that the detected person is a child; or
determine, based on the value being outside of the predetermined range, that the detected person is not the child.

13. The device of claim 12, wherein the program codes, when executed by the one or more processors, configure the device to:
display, on the transformed view image:
the second foot pixel coordinate; and
a result of determining whether the detected person is a child.

14. The device of claim 11, wherein the program codes, when executed by the one or more processors, configure the device to:
extract the first foot pixel coordinate by:
setting a first temporary region to be a region corresponding to the foot of the person detected in the acquired image; and
extracting a coordinate of a lowermost pixel, of one or more pixels in the first temporary region, as the first foot pixel coordinate.

15. The device of claim 11, wherein the program codes, when executed by the one or more processors, configure the device to:
extract the head pixel coordinate by:
setting a second temporary region to be a region corresponding to the head of the person detected in the acquired image; and
extracting a coordinate of an uppermost pixel, of one or more pixels in the second temporary region, as the head pixel coordinate.

16. The device of claim 11, wherein the program codes, when executed by the one or more processors, configure the device to:
generate of the transformed view image by:
obtaining intrinsic and extrinsic parameters of the camera;
converting, via a homography matrix based on the intrinsic and extrinsic parameters, each point, of a plurality of points in the acquired image, into a point in the transformed view image;
generating, based on the converting, a look-up table; and
generating, based on the look-up table and the acquired image, the transformed view image.

17. The device of claim 16, wherein the program codes, when executed by the one or more processors, configure the device to:
further comprising:
acquire, based on the homography matrix, the second foot pixel coordinate corresponding to the first foot pixel coordinate.

18. The device of claim 11, wherein the program codes, when executed by the one or more processors, configure the device to: estimate the distance by:
setting the first foot pixel coordinate and a coordinate of the camera in a normalized coordinate system;
determining corresponding coordinates in a world coordinate system, wherein the corresponding coordinates correspond to the first foot pixel coordinate and the coordinate of the camera in the normalized coordinate system; and
estimating, based on the corresponding coordinates in the world coordinate, a distance between the vehicle and the detected person.

19. The device of claim 11, wherein:
the estimating of the distance comprises
estimating the distance by using Equation 1 below:
$$d = \sqrt{{( {C}^{′} {P}^{′} )}^{2} + {( {PP}^{′} )}^{2}} \qquad Equation 1$$
where d denotes the distance, and C′P′ is calculated by using Equation 2:
$${C}^{′} {P}^{′} = {CC}^{′} * tan ( \frac{π}{2} + {θ}_{tilt} - {tan}^{- 1} v ) \qquad Equation 2$$
where, CC′ denotes a height of the camera, θₜᵢₗₜ denotes a tilt angle of the camera, v denotes a y coordinate of the first foot pixel coordinate, and PP′ is calculated by using Equation 3:
$${PP}^{′} = u * \frac{{CP}^{′}}{{Cp}^{′}} \qquad Equation 3$$
where, u denotes an x coordinate of the first foot pixel coordinate, CP′ is calculated by using Equation 4, and Cp′ is calculated by using Equation 5:
$${CP}^{′} = \sqrt{{( {CC}^{′} )}^{2} + {( {C}^{′} {P}^{′} )}^{2}} \qquad Equation 4$$
$${Cp}^{′} = \sqrt{1 + {v}^{2}} \qquad Equation 5$$
where, CC′ denotes the height of the camera, v denotes the y coordinate of the first foot pixel coordinate, and C′P′ is calculated by using Equation 2.

20. The device of claim 11, wherein the estimating the height comprises:
estimating, as the height, a value of Z of coordinates (X, Y, Z) obtained by converting the head pixel coordinate (x, y) into a world coordinate system by using Equation 6:
$$[ \begin{matrix}X \\ Y \\ Z \\ 1\end{matrix} ] = {s [ R \vert t ]}^{- 1} {K}^{- 1} [ \begin{matrix}x \\ y \\ 1\end{matrix} ] \qquad Equation 6$$
where, K denotes an intrinsic parameter matrix of the camera, [R|t] denotes an extrinsic parameter matrix of the camera, and s denotes the distance.
